(19) United States
(12) Patent Application Publication
(10) Pub. No.: US 2017/0146134 A1
(43) Pub. Date: May 25, 2017

(54) Shut-Off Valve For Liquefied Natural Gas

(71) Applicant: LUXEMBOURG PATENT COMPANY S.A., Lintgen (LU)

(72) Inventors: Johan BROECHLER, Russange (FR); Pascal CHIR, Montigny-les-Metz (FR); Jean-Claude SCHMITZ, Heisdorf (LU)

(21) Appl. No.: 15/323,534

(22) PCT Filed: Jun. 30, 2015
(86) PCT No.: PCT/EP2015/064885

§ 371 Date: Jan. 3, 2017

(30) Foreign Application Priority Data
Jul. 4, 2014 (LU) LU92493

(51) Int. Cl. F16K 1/44; F25J 1/00; F25J 1/02; F16K 41/04

(52) U.S. Cl. CPC F16K 1/443; F16K 41/043; F25J 1/0022; F25J 1/0257

(57) ABSTRACT

The invention is directed to a valve for gas under pressure, for example at temperatures below −100° C., comprising a body with a gas inlet, a gas outlet and a passage connecting the inlet with the outlet; a shut-off device for closing the gas passage; a spindle designed for operating the shut-off device; and at least one gasket between the spindle and the body. The valve further comprises at least one cavity around the spindle for accumulating particles separated from the at least one gasket while operating the spindle and the shut-off device, for example at temperatures below −100° C.

### CROSS-REFERENCE TO RELATED APPLICATIONS

The present invention is the US national stage under 35 U.S.C. §371 of International Application No. PCT/EP2015/064885, which was filed on Jun. 30, 2015, and which claims the priority of application LU 92493 filed on Jul. 4, 2014, the content of which (text, drawings and claims) are incorporated here by reference in its entirety.

### FIELD

The invention is directed to a valve for pressurized gas, more particularly for pressurized gas operating at low temperature like liquefied natural gas (LNG).

### BACKGROUND

Prior art patent document published CN 202140576 U discloses a low-temperature shut-off valve comprising a body with a gas inlet, a gas outlet and gas passage between the inlet and outlet, a hand wheel and shut-off device in the valve body for closing the gas passage by operating the hand wheel. The shut-off device comprises a movable closure member that is in threaded engagement with the body. A spindle supporting the hand wheel rotatably engages with the movable closure member. The spindle comprises a shoulder abutting against a corresponding shoulder on a cap portion of the body. A first gasket is provided between the shoulder of the spindle and the corresponding shoulder of the cap portion. This first gasket is ring shaped with a L-shaped cross-section. A portion of the gasket extends between the external surface of the spindle and the internal surface of the body. A second gasket is arranged around the spindle at a location that is more distal from the shut-off device. This second gasket is housed in the cap portion and is pressed by a sleeve that is in contact with the hand wheel via a sliding washer. The hand wheel is able to slide along the spindle and a spring is arranged between a distal end of the spindle and the hand wheel so as to press it towards the valve body. This urging force is transmitted to the sleeve via the sliding washer. This force is then further transmitted to the second gasket for pressing it against the external surface of the spindle.

During operation of the above valve at low temperature, e.g. at less than −100° C. and even less than −150° C., as is usual with LNG, the gaskets made of elastomer become hard and frictional movement against them can produce elastomer particles. These particles can accumulate inside the valve and increase the torque necessary for operating it. Such valves require already a relatively high torque for operating them due essentially to the low temperatures and the resulting high stiffness of the gaskets. Any sensible increase in the operating torque is to be avoided.

### SUMMARY

The invention has for a technical problem to provide a valve that overcomes at least one of the drawbacks of the above mentioned prior art. More particularly, the invention has for a technical problem to provide a valve that is suitable for gases at low temperatures, e.g. below −100° C., while keeping a reduced operating torque and being gas tight.

The invention is directed to a valve for gas under pressure, for example at temperatures below −100° C., comprising: a body with a gas inlet, a gas outlet and a passage connecting the inlet with the outlet; a shut-off device for closing the gas passage; a spindle designed for operating the shut-off device; at least one gasket between the spindle and the body; wherein the valve further comprises at least one cavity around the spindle for accumulating particles separated from the at least one gasket while operating the spindle and the shut-off device, for example at temperatures below −100° C.

According to various embodiments, the valve comprises a first gasket and a second gasket, and a first cavity at least one cavity being between the first and second gaskets.

According to various embodiments, the first cavity is shaped as a groove on the external surface of the spindle.

According to various embodiments, the cross-section of the first cavity is generally rectangular shaped with a width that is more than 5 times higher, n various instances 10 times higher, than the height. The width is meant to be measured parallel to the longitudinal axis of the spindle and the height is meant to be measures perpendicularly to the axial direction.

According to various embodiments, the cross-section of the first cavity is generally rectangular shaped with a width that is comprised between 1 mm and 8 mm, in various instances between 1 mm and 5 mm, and/or a height that is comprised between 0.1 mm and 1 mm, in various instances between 0.1 mm and 0.5 mm.

According to various embodiments, the first cavity is in front of a cylindrical internal surface of the body that supports the spindle.

According to various embodiments, the spindle comprises a shoulder axially abutting against a corresponding shoulder of the valve body, the first gasket being positioned between the shoulder of the spindle and the shoulder of the body.

In various instances the first gasket has an at least generally rectangular cross-section.

According to various embodiments, the shut-off device comprises a movable closure member housed in the valve body, the member cooperating with a seat around the gas passage in the body, a second cavity of the valve being formed in the member, the spindle engaging with the second cavity for actuating the member.

According to various embodiments, the second cavity widens towards the spindle so as to be able to collect the particles separated from the first gasket while operating the spindle and the shut-off device.

According to various embodiments, the second cavity widens up to the maximum diameter of the shoulder of the spindle.

According to various embodiments, the external surface of the shoulder of the spindle tapers towards the closure member, the internal surface of second cavity on the member being shaped to conform to the tapering external surface of the shoulder.

According to various embodiments, the movable closure member is in threaded engagement with the body, and the engagement between the spindle and the second cavity is in rotation. The spindle and the second cavity can slide relative to each other.

According to various embodiments, the second cavity extends opposite to the spindle, beyond a proximal end of the spindle in the cavity to create a space for accumulating the particles from the at least one gasket.

According to various embodiments, the body comprises a main portion that houses and guides the movable closure member, and an auxiliary cap portion that is screwed on the main portion and that bears the spindle, the first gasket and/or the second gasket.

According to various embodiments, the auxiliary cap portion comprises a bore portion surrounding the shoulder of the spindle and configured for receiving, when the shut-off device is in an open position, an end of the movable closure element corresponding to the opening of the second cavity.

According to various embodiments, the shoulder of the spindle comprises a surface that extends radially and that contacts the first gasket, the surface being raised at its external portion, and/or the shoulder of the valve body comprises a surface that extends radially and that contacts the first gasket, the surface comprises at least one rib at its external portion that penetrates the gasket.

According to various embodiments, the second gasket cooperates with the cylindrically shaped external surface of the spindle, at an axial position of the spindle that is more distant from the shut-off device than the first gasket.

According to various embodiments, the valve further comprises: a hand wheel in rotational engagement with the spindle; a sleeve around the spindle between the hand wheel and the second gasket; and a resilient biasing means acting between a distal end of the spindle and the hand wheel so as to axially press the hand wheel against the sleeve and thereby press the second gasket.

According to various embodiments, the second gasket is a ring with a generally trapezoid cross-section with the larger base in contact with the spindle and the smaller base in contact with the body.

According to various embodiments, one leg of the trapezoid cross-section of the second gasket is against a corresponding bevelled surface of the body and the other opposite leg of the trapezoid is against a corresponding bevelled surface of the sleeve.

According to various embodiments, the larger base of the trapezoid cross-section of the second gasket comprises a recess, for example at a middle portion.

According to various embodiments, the resilient biasing means comprises stacked Belleville washers.

According to various embodiments, the valve comprises a cage housing the resilient biasing means and limiting the compression of the means by the hand wheel.

The invention is particularly interesting in that its features permit to limit the torque necessary for opening and closing the valve, for example when used with gases at low temperatures where the gaskets, usually made of elastomer materials, become hard and stiff. This is particularly true for valves which cannot contain any loose lubricant like lubricating oil or grease.

### DRAWINGS

FIG. 1 is a sectional view of a valve in accordance with various embodiments of the invention.

FIG. 2 is a magnified view of the area II in FIG. 1, in accordance with various embodiments of the invention.

### DETAILED DESCRIPTION

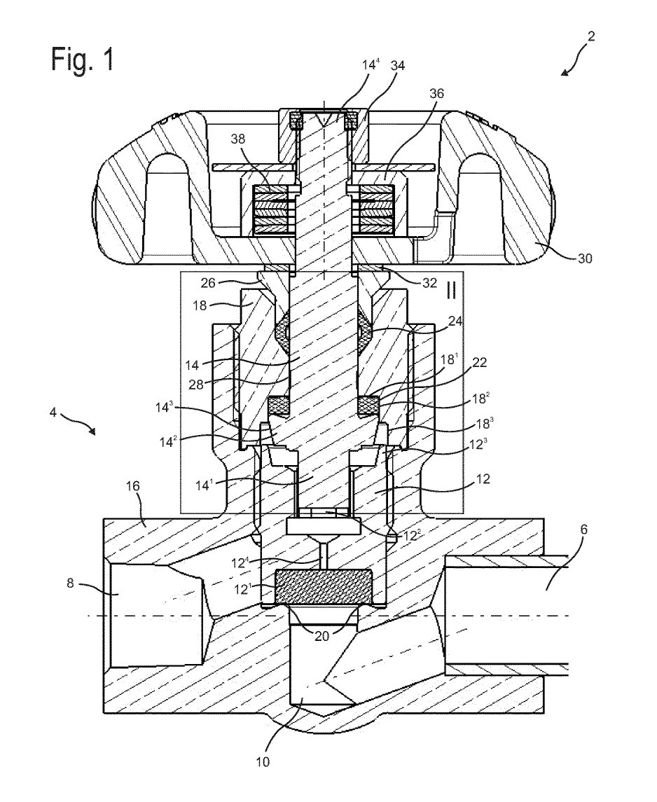

The valve 2 illustrated in FIG. 1 comprises essentially a body 4, a gas inlet 6, a gas outlet 8 and a gas passage 10 fluidly interconnecting the inlet 6 and outlet 8.

A shut-off device consisting essentially of a movable closure member 12 is provided in the body 4 for closing the gas passage 10. The movable closure member 12 is operated by a spindle 14 extending through the valve body 4.

The valve body 4 is comprised of a main portion 16 and a cap 18 that is attached to the main portion 16, for instance by screwing. The main portion comprises a bore that houses the movable closure member 12, the spindle 14 and the cap 18. The movable closure member 12 is generally cylindrically shaped and comprises at its external surface a male thread that engages a corresponding female thread on an internal surface of the bore of the main portion 16 of the body. It comprises a front surface with a recess housing an element 121 of softer material that cooperates in a tightly fashion with a valve seat 20 that is formed in the valve body 4 around the gas passage 10. The element 121 can be made of plastic material.

The movable closure member 12 comprises also a cavity 122 that opens in a direction that is opposite to the element 121 and the valve seat 20. This cavity 122 comprises a cylindrical internal surface that receives and engages in rotation only with a proximal end 141 of the spindle 14. The proximal end 142 of the spindle 14 and the internal surface of the cavity 122 of the closure member 12 can take various shapes which are as such well known from the skilled person, e.g. splines or any section that is not symmetrical in rotation.

The spindle 14 comprises a shoulder 142 that cooperates with a corresponding shoulder 181 and bore 182 on the cap 18. A generally ring shaped first gasket 22 is housed in the chamber delimited by these two shoulders 142 and 181 and the bore 182.

The external surface 143 of the shoulder 142 of the spindle 14 can be bevelled so as to taper towards the shut-off device 12. The shoulder 142 of the spindle 14 at the maximum diameter of the tapering external surface 143 closes the chamber that houses the first gasket 22 while keeping a minimal surface of contact between the external surface 143 of the spindle and the corresponding surface of the bore 182 of the cap 18.

In addition, the cap 18 forms a second bore 183, larger than the first one bore 182 and positioned in front of the tapering external surface 143 of the shoulder 142 of the spindle 14. This bore 183 can receive the raised end 123 of the movable closure member 12 that is opposed to the valve seat 20.

The cavity 122 in the movable closure member 12 widens towards the spindle 14, thereby forming the raised end 123. When operating the spindle 14, the frictional forces acting on the first gasket 22 are likely to produce particles of the elastomer material of the gasket. Under the condition that the valve is positioned upwardly as illustrated in FIG. 1, e.g., with the axis of the spindle generally vertical and with the distal end 144 of the spindle 14 oriented upwardly, the particles separating from the first gasket 22 can fall downwardly by gravity and be collected by the funnel-shaped upper internal surface of the cavity 122. The particles can then pass through the mechanical play between the external surface of the proximal end 141 of the spindle 14 and the corresponding internal surface of the movable closure member 12, and then accumulate at the bottom of the cavity 122.

As is visible in FIG. 1, a passage 124 can be foreseen at the bottom of the cavity 122, interconnecting the cavity with the housing for the element 121 cooperating with the valve seat 20.

The valve 2 comprises a second gasket 24 that is ring-shaped and with a trapezoid cross-section. The larger base of the trapezoid cross-section is in contact with the external cylindrical surface of the spindle 14 whereas the smaller base is in contact with the internal surface of the cap 18. A sleeve 26 is slidably provided around the spindle 14 for pressing the second gasket 24.

The spindle 14 comprises at its external surface a groove 28, the groove being between the first gasket 22 and the second gasket 24. The groove forms a cavity that can accumulate particles separated from the gaskets 22 and 24, more particularly from the second gasket 24, similarly to the cavity 122 in the movable closure member 12. The groove 28 can have a generally rectangular cross shape with a width that is larger, in various instances at least 5 times larger, for example at least 10 times larger than the height.

The valve 2 comprises a hand wheel 30 that is in rotatable engagement with the distal end 144 of the spindle 14. The hand wheel 30 can slide along the spindle while being in rotatable engagement. To that end the spindle 14 can provide a cross-section with a non-circular outer surface, e.g. a square outer surface, that engages with a corresponding inner surface of the hand wheel 30. A sliding or anti-friction washer 32 can be interposed between the lower surface of the hand wheel 30 and the upper surface of the sleeve 26. A stack of Belleville spring washers 38 is provided around the distal end 144 of the spindle 14, between a nut 34 that is engaged with the distal end, and the hand wheel 30. The spring washers 38 can be housed in an opened housing 36 that is interposed between the nut 34 and the springs 38 and that extends at the lateral surface of the springs up to close to the surface of the hand wheel that is in contact with the spring washers. The spring washers exert a biasing force on the hand wheel that is oriented downward, e.g., in the direction of the valve body so as to transmit that force to the sleeve 26 and to the second gasket 24. The second gasket 24 is thereby constantly under pressure so as to cooperate in a gas tight fashion with the spindle 14. The biasing force of the springs is also transmitted to the spindle 14 by means of the nut 34. The spindle 14 is then biased upwardly, e.g., in a direction opposite to the valve body and that presses the first gasket 22 between the shoulders 142 and 181, so as to provide a first gas tight barrier between the spindle 14 and the body 4.

The use of the housing 36 for the resilient biasing means 38 is interesting for it permits to keep the washers in position so as to work properly. It permits also to facilitate the assembly of the valve. In various instances, when tightening the nut 34 in order to pre-stress both first and second gaskets 22 and 24, the nut can be tighten until the housing 36 contacts the hand wheel 30, so as to ensure a minimum and also an adequate pre-stress of the gaskets. Any wear or matting of one or both of the gaskets will be compensated by the biasing force of the pre-stressed resilient means 38.

During operation of the valve, for example at low and very low temperatures, e.g., less than −100° C., or even less than −150° C., which is typical for liquefied natural gas (LNG), the material of the gaskets 22 and 24 becomes hard and stiff. The contact pressure between the gaskets and the spindle resulting from the mechanical pre-stress and/or the fluid pressure has for effect that the material of the gaskets can be subject to mechanical wear during rotation of the spindle, the wear resulting in the separation of material in small particles or even powder. These particles can accumulate at some places in the valve, for example between moving parts and non-moving parts, leading to an increase of the operating torque or even a blocking of the valve. The cavity 28 formed on the outer surface of the spindle 14 can accumulate these particles and avoid a blocking of the spindle 14. In case the valve is in an upright position as illustrated in the FIG. 1, the cavity 28 can collect the particles from the second gasket 24 moving down by gravity. In case the valve would be in another orientation, e.g. with the spindle horizontal or downward, the cavity 28 can collect the particles from the first gasket 22. The cavity 122 formed in the movable closure member 12 permits also to collect the particles from the first gasket 22, for example when the valve is in an upright position as illustrated in FIG. 1. The funnel-shaped opening 123 of the cavity 122 is particularly useful for collecting the particles and prevent them from reaching the threaded engagement between the movable closure member 12 and the body 16.

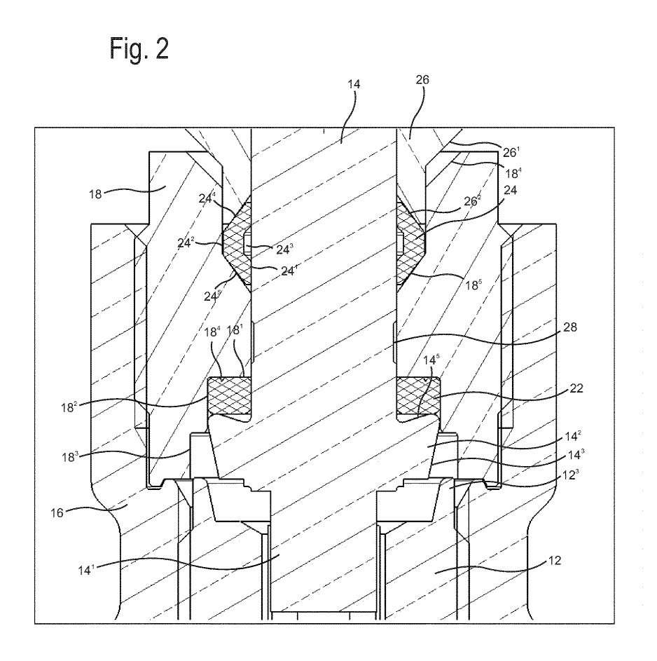

FIG. 2 is a magnified view of the area II in FIG. 1, corresponding to the two gas tight barriers of the valve.

It is exemplarily illustrated in FIG. 2 that the surface 145 of shoulder 142 of the spindle 14 that contacts the first gasket 22 is not flat but rather is slightly bevelled. That surface 145 is shaped so that its external portion is closer to the shoulder 181 of the body than its internal portion. The shoulder 181 of the body comprises also a circular rib 184 that is intended to penetrate into the first gasket 22. This rib 184 is positioned at an external circumferential portion of the shoulder 181 in order to be at least approximately aligned with the raised external portion of the shoulder 142. The gasket 22 is therefore more stressed at its external portion so to be properly penetrated by the rib 184 and provide an adequate first gas tight barrier.

It is exemplarily illustrated in FIG. 2 that a flared external surface 261 of the sleeve 26 that can abut against the corresponding external surface 184 of the plug before the front end 262 contacting the gasket 24 would reach the bottom of the cavity of the gasket.

Still in FIG. 2 it can be observed that the shape of the second gasket 24 can have a trapezoid cross-section. The larger base 241 is in contact with the external surface of the spindle 14 whereas the smaller base 242 is in contact with the internal surface of the plug 18. The larger base 241 can comprise a groove 243 that provides some room for deformation of the gasket. The side or leg 244 is in contact with the corresponding surfaces 262 of the sleeve 26 and the other opposite side or leg 245 is in contact with the corresponding surfaces 185 of the sleeve plug 18. The axial force exerted by the sleeve 26 via its contact surface 262 is converted into a radial force thanks to the inclination of the surfaces 262 and 185.

In various embodiments, the different elements of the valve 2, like the main body 16, the plug 18, the spindle 14 and/or the movable closure element 12 can be made of brass, steel and/or stainless steel. In various embodiments, some elements, such as the movable closure element 12 and/or the spindle 14 can be coated with Teflon® so as to lower the frictional forces.

1.-23. (canceled)

24. A valve for gas under pressure at temperatures below −100° C., said valve comprising:
a body with a gas inlet, a gas outlet and a passage connecting the inlet with the outlet;
a shut-off device for closing the gas passage;
a spindle designed for operating the shut-off device;
at least one gasket between the spindle and the body; and
at least one cavity around the spindle for accumulating particles separated from the at least one gasket while operating the spindle and the shut-off device at temperatures below −100° C.

25. The valve according to claim 24 further comprising a first gasket and a second gasket, and a first cavity between the first and second gaskets.

26. The valve according to claim 25, wherein the first cavity is shaped as a groove on the external surface of the spindle.

27. The valve according to claim 26, wherein the cross-section of the first cavity is generally rectangular shaped with a width that is more than 5 times higher than the height.

28. The valve according to claim 27, wherein the cross-section of the first cavity is generally rectangular shaped with at least one of a width that is comprised between 1 mm and 8 mm, and a height that is comprised between 0.1 mm and 1 mm.

29. The valve according to claim 28, wherein the first cavity is in front of a cylindrical internal surface of the body that supports the spindle.

30. The valve according to claim 29, wherein the spindle comprises a shoulder axially abutting against a corresponding shoulder of the valve body, the first gasket being positioned between the shoulder of the spindle and the shoulder of the body.

31. The valve according to claim 30, wherein the shut-off device comprises a movable closure member housed in the valve body, the member cooperating with a seat around the gas passage in the body, a second cavity of the valve being formed in the member, the spindle engaging with the second cavity for actuating the member.

32. The valve according to claim 31, wherein the second cavity widens towards the spindle so as to be able to collect the particles separated from the first gasket while operating the spindle and the shut-off device.

33. The valve according to claim 32, wherein the second cavity widens to the maximum diameter of the shoulder of the spindle.

34. The valve according to claim 33, wherein the external surface of the shoulder of the spindle tapers towards the movable closure member, the internal surface of the second cavity on the member being shaped to conform to the tapering external surface of the shoulder.

35. The valve according to claim 34, wherein in the movable closure member is in threaded engagement with the body, and the engagement between the spindle and the second cavity is in rotation.

36. The valve according to claim 35, wherein the second cavity extends opposite to the spindle, beyond a proximal end of the spindle in the cavity to create a space for accumulating the particles from at least one of the first and second gaskets.

37. The valve according to claim 36, wherein the body comprises a main portion housing and guiding the movable closure member, and an auxiliary cap portion screwed on the main portion and bearing the spindle, the first gasket and/or the second gasket.

38. The valve according to claim 37, wherein the auxiliary cap portion comprises a bore portion surrounding the shoulder of the spindle and configured for receiving, when the shut-off device is in an open position, an end of the movable closure element corresponding to the opening of the second cavity.

39. The valve according to claim 38, wherein at least one of the shoulder of the spindle comprises a surface that extends radially and that contacts the first gasket, the surface being raised at its external portion, and the shoulder of the valve body comprises a surface that extends radially and that contacts the first gasket, the surface comprising at least one rib at its external portion that penetrates the gasket.

40. The valve according to claim 39, wherein the second gasket cooperates with a cylindrically shaped external surface of the spindle, at an axial position of the spindle that is more distant from the shut-off device than the first gasket.

41. The valve according to claim 40 further comprising:
a hand wheel in rotational engagement with the spindle;
a sleeve around the spindle between the hand wheel and the second gasket; and
resilient biasing means acting between a distal end of the spindle and the hand wheel so as to axially press the hand wheel against the sleeve and thereby press the second gasket.

42. The valve according to claim 41, wherein the second gasket is a ring with a generally trapezoid cross-section with the larger base in contact with the spindle and the smaller base in contact with the body.

43. The valve according to claim 42, wherein one leg of the trapezoid cross-section of the second gasket is against a corresponding beveled surface of the body and the other opposite leg of the trapezoid is against a corresponding beveled surface of the sleeve.

44. The valve according to claim 43, wherein the larger base of the trapezoid cross-section of the second gasket comprises a recess at a middle portion.

45. The valve according to claim 44, wherein the resilient biasing means comprises stacked Belleville washers.

46. The valve according to claim 45 further comprising a cage housing the resilient biasing means and limiting the compression of the resilient means by the hand wheel.
